(19) United States
(12) Patent Application Publication
(10) Pub. No.: US 2025/0369811 A1
(43) Pub. Date: Dec. 4, 2025

(54) PRESSURE SENSOR

(71) Applicant: Japan Display Inc., Tokyo (JP)

(72) Inventors: Shinichiro OKA, Tokyo (JP); Chiharu KABURAGI, Tokyo (JP); Yoshinori AOKI, Tokyo (JP); Fumiyuki OOKUNI, Tokyo (JP); Takuo KAITOH, Tokyo (JP); Yuta HAGA, Tokyo (JP)

(21) Appl. No.: 19/220,716

(22) Filed: May 28, 2025

(30) Foreign Application Priority Data
May 30, 2024 (JP) 2024-088059

(51) Int. Cl. G01L 1/22

(52) U.S. Cl. CPC G01L 1/2293

(57) ABSTRACT

According to one embodiment, a pressure sensor includes a first detection area, a second detection area, and one or plurality of partitions. The first detection area includes a first transistor, a first detection electrode electrically connected to the first transistor, and a first pressure-sensitive layer provided on the first detection electrode. The second detection area includes a second transistor, a second detection electrode electrically connected to the second transistor, and a second pressure-sensitive layer provided on the second detection electrode. The partition is provided between the first pressure-sensitive layer and the second pressure-sensitive layer.

### CROSS-REFERENCE TO RELATED APPLICATIONS

This application is based upon and claims the benefit of priority from Japanese Patent Application No. 2024-088059, filed May 30, 2024, the entire contents of which are incorporated herein by reference.

### FIELD

Embodiments described herein relate generally to a pressure sensor.

### BACKGROUND

Various pressure sensors capable of detecting pressure distribution have been proposed. With respect to such pressure sensors, pressure sensors capable of suppressing reduction in reliability are demanded.

### BRIEF DESCRIPTION OF THE DRAWINGS

FIG. 1 is a plan view showing a configuration example of a pressure sensor of the first embodiment.

FIG. 2 is a plan view showing a configuration example of the pressure sensor shown in FIG. 1.

FIG. 3 is a schematic cross-sectional view of the pressure sensor along III-III line in FIG. 2.

FIG. 4 is a circuit diagram showing an example of circuit configurations of the pressure sensor shown in FIG. 1.

FIG. 5 is a cross-sectional view illustrating a state where an input surface of the pressure sensor shown in FIG. 1 is pressed.

FIG. 6 is a plan view showing a configuration example of a pressure sensor of the second embodiment.

FIG. 7 is a schematic cross-sectional view of the pressure sensor along VII-VII line in FIG. 6.

FIG. 8 is a plan view showing a configuration example of a pressure sensor of the third embodiment.

FIG. 9 is a schematic cross-sectional view of the pressure sensor along IX-IX line in FIG. 8.

FIG. 10 is a plan view showing a configuration example of a detection unit of the pressure sensor shown in FIG. 1.

FIG. 11 is a plan view showing a configuration example of a detection unit of the pressure sensor shown in FIG. 1.

FIG. 12 is a plan view showing a configuration example of a detection unit of the pressure sensor shown in FIG. 1.

FIG. 13 is a plan view showing a configuration example of a detection unit of the pressure sensor shown in FIG. 1.

FIG. 14 is a view showing an example of relationships among pressure applied to an input surface and current values.

FIG. 15 is a plan view showing a configuration example of a detection unit of the pressure sensor shown in FIG. 1.

FIG. 16 is a plan view showing a configuration example of a detection unit of the pressure sensor shown in FIG. 1.

### DETAILED DESCRIPTION

In general, according to one embodiment, a pressure sensor includes a first detection area, a second detection area, and one or plurality of partitions. The first detection area includes a first transistor, a first detection electrode electrically connected to the first transistor, and a first pressure-sensitive layer provided on the first detection electrode. The second detection area includes a second transistor, a second detection electrode electrically connected to the second transistor, and a second pressure-sensitive layer provided on the second detection electrode. The partition is provided between the first pressure-sensitive layer and the second pressure-sensitive layer.

The above configuration can provide a pressure sensor capable of suppressing reduction in reliability.

Some embodiments will be described hereinafter with reference to the accompanying drawings.

The disclosure is a mere example, and proper changes within the spirit of the invention, which are easily conceived by a person of ordinary skill in the art, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. In addition, in the specification and drawings, structural elements that function in the same or a similar manner to those described in connection with preceding drawings are denoted by like reference numbers, detailed description thereof being omitted unless necessary.

### First Embodiment

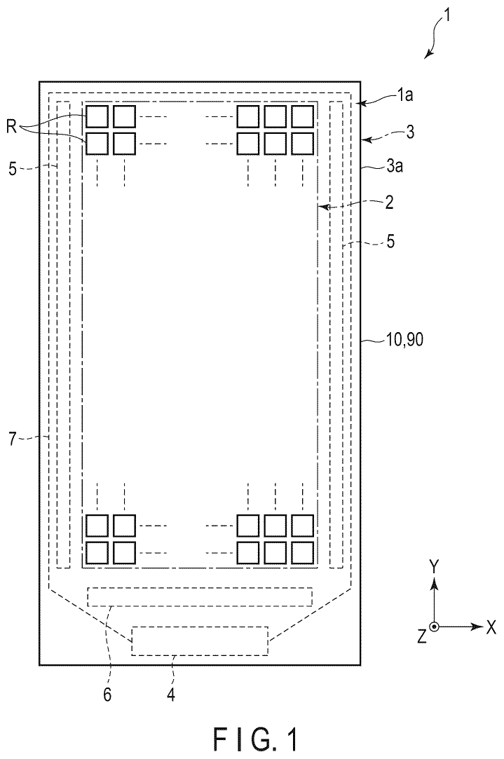

FIG. 1 is a plan view showing a configuration example of a pressure sensor 1 of the present embodiment. For example, a first direction X, a second direction Y, and a third direction Z are orthogonal to one another but may intersect at an angle other than 90 degrees. The first direction X and the second direction Y correspond to, for example, directions parallel to a main surface of a substrate constituting the pressure sensor 1, and the third direction Z corresponds to a thickness direction of the pressure sensor 1. In the present specification, a direction from a substrate 10 to a protective layer 90 is referred to as an “upper side” (or simply, “upper” or “above”) and a direction from the protective layer 90 to the substrate 10 is referred to as a “lower side” (or simply, “lower” or “below”). Expressions such as “a second member on/above a first member” and “a second member under/below a first member” signify that the second member may be in contact with the first member or may be spaced apart from the first member. In addition, an observation position at which the pressure sensor 1 is observed is assumed to be located on the tip side of the arrow indicating the third direction Z, and viewing from the observation position toward the X-Y plane defined by the first direction X and the second direction Y is referred to as a plan view.

In the present embodiment, the pressure sensor 1 is a pressure distribution sensor. The pressure sensor 1 comprises a substrate 10. The substrate 10 is formed into a flat plate shape parallel to the X-Y plane. For example, the substrate 10 has a rectangular shape in plan view.

In the example in FIG. 1, the pressure sensor 1 comprises a protective layer 90. The protective layer 90 is formed into a flat plate shape parallel to the X-Y plane. The substrate 10 overlaps the protective layer 90 in plan view.

The pressure sensor 1 has an input surface 1a on its one surface. Pressure is applied to the input surface 1a. In the example in FIG. 1, the pressure sensor 1 has the input surface 1a on the surface of the protective layer 90 opposite to a surface facing the substrate 10. The pressure sensor 1 detects pressure applied to the input surface 1a.

The input surface 1a comprises a detection unit 2 for detecting pressure and a non-detection unit 3 formed in a frame shape and surrounding the detection unit 2 in plan view. The detection unit 2 has a plurality of detection areas R. In the example in FIG. 1, the plurality of detection areas R are arrayed in the first direction X and the second direction Y.

The pressure sensor 1 further comprises a connection unit 4, a gate line drive circuit 5, a signal line select circuit 6, a common wire 7, and the like. The pressure sensor 1 comprises gate lines 8 and signal lines 9 (both not shown). The connection unit 4, the gate line drive circuit 5, the signal line select circuit 6, the common wire 7, the gate lines 8, and the signal lines 9 are provided between the substrate 10 and the protective layer 90. Each of the connection unit 4, the gate line drive circuit 5, the signal line select circuit 6, and the common wire 7 overlaps the non-detection unit 3 in plan view.

The connection unit 4 connects the pressure sensor 1 with a drive integrated circuit (IC) in the exterior of the pressure sensor 1. The drive integrated circuit (IC) is not shown. The drive IC may be mounted as a chip on film (COF) on a flexible printed substrate or a rigid substrate both connected to the connection unit 4. The drive IC may be mounted as a chip on glass (COG) in an area overlapping the non-detection unit 3 of the substrate 10.

The gate line drive circuit 5 drives the plurality of gate lines 8 based on various control signals from the drive IC. The gate line drive circuit 5 sequentially or simultaneously selects the gate lines 8 and then supplies the selected gate lines 8 with gate drive signals.

The signal line select circuit 6 is a switch circuit that sequentially or simultaneously selects the signal lines 9. The signal line select circuit 6 is, for example, a multiplexer. The signal line select circuit 6 connects the selected signal lines 9 with the drive IC based on the selected signals supplied from the drive IC.

The common wire 7 supplies the common electrode with a prescribed voltage and is arrayed along an outer edge 3a of the non-detection unit 3. The common wire 7 is connected to the drive IC via the connection unit 4 and is supplied with a constant voltage from the drive IC.

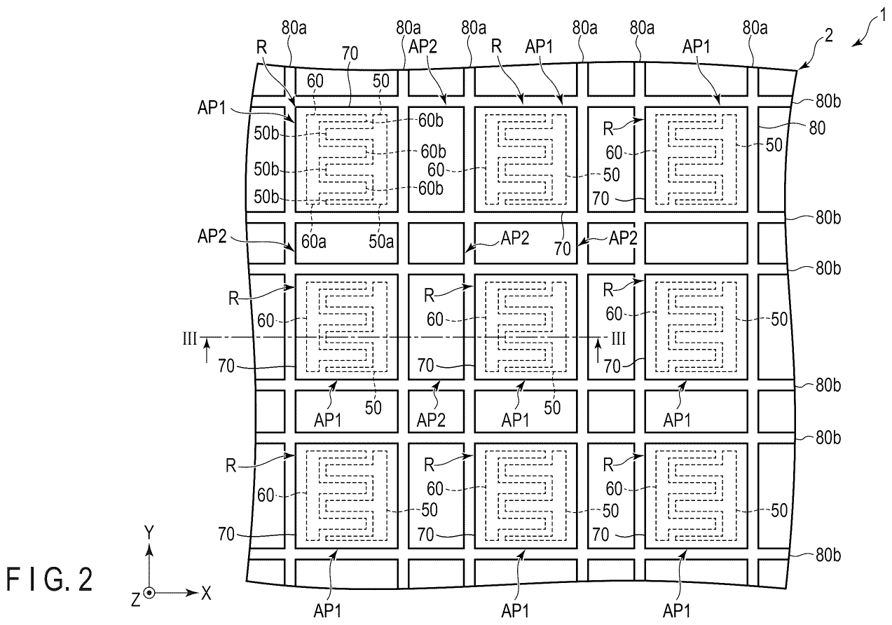

FIG. 2 is a plan view showing a configuration example of the pressure sensor 1 shown in FIG. 1. The following describes a detection unit 2 of the pressure sensor 1. FIG. 2 omits the illustration of the protective layer 90.

The pressure sensor 1 comprises the plurality of detection areas R and a partition 80. In the example in FIG. 2, the plurality of detection areas R are arrayed in the first direction X and the second direction Y.

Each of the plurality of detection areas R comprises a detection electrode 50, a common electrode 60, a pressure-sensitive layer 70, and a transistor 30 (not shown). The detection electrode 50 comprises an electrode 50a extending in the second direction Y, and a plurality of electrodes 50b extending in the first direction X from the electrode 50a. The common electrode 60 comprises an electrode 60a extending in the second direction Y, and a plurality of electrodes 60b extending in the first direction X from the electrode 60a. The electrodes 50b and the electrodes 60b are alternately arranged in the second direction Y. The pressure-sensitive layer 70 overlaps the detection electrode 50 and the common electrode 60. For example, the pressure-sensitive layer 70 has a rectangular shape in plan view.

The partition 80 is provided between two pressure-sensitive layers 70 adjacent to each other in the first direction X or the second direction Y. In the example in FIG. 2, the partition 80 includes a plurality of first partitions 80a arrayed in the first direction X and extending in the second direction Y and a plurality of second partitions 80b arrayed in the second direction Y and extending in the first direction X. Two of the first partitions 80a are provided between the pressure-sensitive layers 70 adjacent to each other in the first direction X. Two of the second partitions 80b are provided between the pressure-sensitive layers 70 adjacent to each other in the second direction Y. The first partition 80a and the second partition 80b intersecting each other are connected to each other. Thus, as a whole, the partition 80 is formed into a lattice shape surrounding each of the plurality of pressure-sensitive layers 70.

In the example in FIG. 2, the partition 80 includes a plurality of apertures AP1 overlapping the pressure-sensitive layer 70. The partition 80 further comprises a plurality of apertures AP2 not overlapping the pressure-sensitive layer 70. In the example in FIG. 2, the aperture AP1 has a rectangular shape of the same size as the pressure-sensitive layer 70. The partition 80 has rows in which the apertures AP1 and AP2 are alternately arranged in the first direction X and rows in which the plurality of apertures AP2 are repeatedly arranged in the first direction X. These rows are alternately arranged in the second direction Y. The partition 80 has rows in which the apertures AP1 and AP2 are alternately arranged in the second direction Y and rows in which the plurality of apertures AP2 are repeatedly arranged in the second direction Y. These rows are alternately arranged in the first direction X.

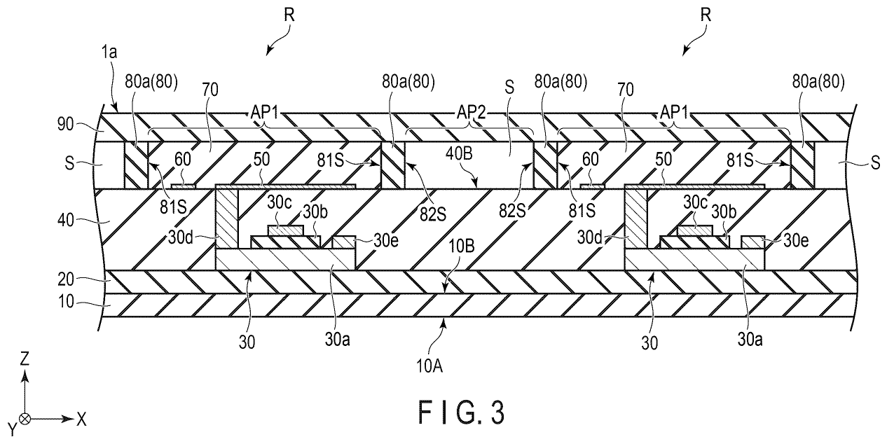

FIG. 3 is a schematic cross-sectional view of the pressure sensor 1 along III-III line in FIG. 2.

The pressure sensor 1 comprises the substrate 10, an insulating layer 20, a plurality of transistors 30, an insulating layer 40, the plurality of detection electrodes 50, the plurality of common electrodes 60, the plurality of pressure-sensitive layers 70, the partition 80, and the protective layer 90. The pressure sensor 1 further comprises the connection unit 4, the gate line drive circuit 5, the signal line select circuit 6, and the common wire 7 that are shown in FIG. 1. The pressure sensor 1 further comprises the gate lines 8 and the signal lines 9 (both not shown).

The substrate 10 has a main surface (lower surface) 10A and a main surface (upper surface) 10B on the side opposite to the main surface 10A. The main surfaces 10A and 10B are substantially parallel to the X-Y plane. The insulating layer 20 covers the main surface 10B. Each of the plurality of transistors 30 is provided on the insulating layer 20 per the detection area R.

The transistor 30 comprises a semiconductor layer 30a, a gate insulating film 30b, a gate electrode 30c, a drain electrode 30d, and a source electrode 30e. The semiconductor layer 30a is provided on the insulating layer 20. The gate insulating film 30b is provided on the semiconductor layer 30a. The gate electrode 30c is provided on the gate insulating film 30b. The drain electrode 30d is provided on the semiconductor layer 30a. The drain electrode 30d is electrically connected to the gate line 8 (not shown). The source electrode 30e is provided on the semiconductor layer 30a. The source electrode 30e is electrically connected to the signal line 9 (not shown).

The insulating layer 40 covers the insulating layer 20 and each of the plurality of transistors 30. The insulating layer 40 has a surface 40B facing the protective layer 90. The surface 40B is planarized. Though not shown, the connection unit 4, the gate line drive circuit 5, the signal line select circuit 6, the common wire 7, the gate line 8, and the signal line 9 are provided between the main surface 10B and the surface 40B.

Each of the plurality of detection electrodes 50 is provided on the surface 40B per the detection area R. The detection electrode 50 is electrically connected to the drain electrode 30d, and is electrically connected to the transistor 30. Each of the plurality of common electrodes 60 is provided on the surface 40B per the detection area R. In the detection area R, the detection electrode 50 and the common electrode 60 are adjacent to each other via the pressure-sensitive layer 70. The detection electrode 50 is formed on the same plane as the common electrode 60. That is, the pressure sensor 1 comprises what is called a parallel-type electrode.

Each of the plurality of pressure-sensitive layers 70 is formed per the detection area R. The pressure-sensitive layer 70 covers the detection electrode 50 and the common electrode 60. The pressure-sensitive layer 70 contacts the surface 40B between the detection electrode 50 and the common electrode 60. The pressure-sensitive layer 70 contacts the surface 40B between the detection electrode 50 and the partition 80 and between the common electrode 60 and the partition 80.

The partition 80 is provided on the surface 40B. In the example in FIG. 3, two of the first partitions 80a are provided on the surface 40B between the pressure-sensitive layers 70 adjacent to each other. Each of the first partitions 80a has a side surface 81S facing the pressure-sensitive layer 70 and a side surface 82S on the side opposite to the side surface 81S. The side surface 81S contacts the pressure-sensitive layer 70. The side surface 81S of one first partition 80a faces the side surface 81S of another first partition 80a via the pressure-sensitive layer 70. The aperture AP1 is formed between side surfaces 81S facing each other. The detection electrode 50, the common electrode 60, and the pressure-sensitive layer 70 are provided in the aperture AP1.

The side surface 82S of one first partition 80a faces the side surface 82S of another first partition 80a through a gap S. The aperture AP2 is formed between side surfaces 82S facing each other. The surface 40B is exposed in the aperture AP2.

The protective layer 90 covers each of the plurality of pressure-sensitive layers 70 and the partition 80. In the example in FIG. 3, the protective layer 90 covers the entire area of the pressure sensor 1. The protective layer 90 has the input surface 1a on the surface opposite to the surface facing the substrate 10.

The substrate 10 is insulating. For example, the substrate 10 is any of a substrate and a film, both formed of glass or resin such as polyimide (PI). The insulating layers 20 and 40 are inorganic or organic insulating films. For example, the partition 80 is formed of insulating materials such as an acrylic resin and an epoxy resin. The protective layer 90 is a substrate that is insulating and flexible. For example, the protective layer 90 is a substrate or a film both formed of a resin and the like. The detection electrodes 50 and the common electrodes 60 are formed of a metal material such as indium tin oxide (ITO).

The pressure-sensitive layer 70 is formed of an insulating resin containing conductive materials. The conductive materials are, for example, conductive particles. The conductive materials are dispersed in an insulating resin to be spaced apart from one another. For example, the pressure-sensitive layer 70 is conductive elastomers prepared by mixing rubber member with conductive material. For example, the pressure-sensitive layer 70 may be formed by applying insulating resin materials containing conductive materials onto the surface 40B by means of an ink-jet and the like. The pressure-sensitive layer 70 may be formed of two or more types of pressure-sensitive layers having different variation ratios of resistance values in response to applied pressure.

When no pressure is applied to the pressure-sensitive layer 70 formed of insulating resin containing conductive material, the conductive materials in the insulating resin are spaced apart from one another. Thus, the pressure-sensitive layer in this state has a great resistance value. When pressure is applied to the pressure-sensitive layer 70, the insulating resin deforms and thus the conductive materials in the insulating resin are brought into contact with one another or close proximity. This reduces the resistance value of the pressure-sensitive layer 70. When pressure is further applied to the pressure-sensitive layer 70 and deformation amount of the insulating resin further increases, the amount of the conductive materials that are in contact with one another or close proximity increases. This further reduces the resistance value of the pressure-sensitive layer 70. In this manner, the resistance value of the pressure-sensitive layer 70 formed of the insulating resin containing the conductive materials varies in response to pressure applied to the pressure-sensitive layer.

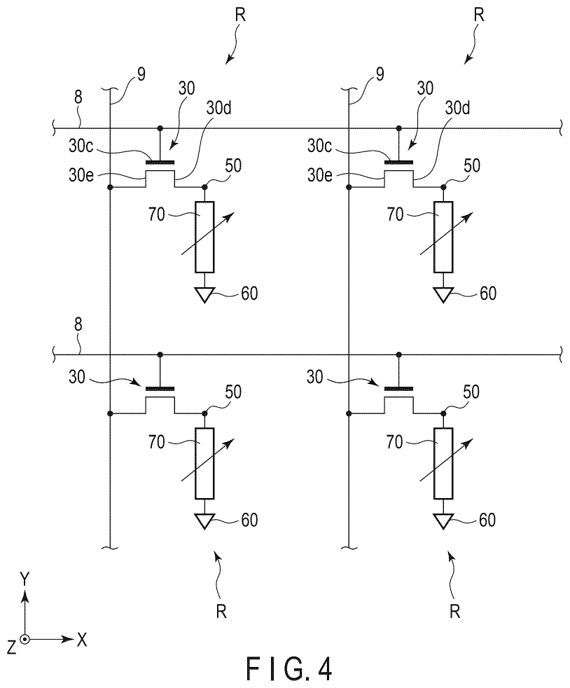

FIG. 4 is a circuit diagram showing an example of circuit configurations of the pressure sensor 1 shown in FIG. 1. As shown in FIG. 4, the gate electrode 30c is electrically connected to the gate line 8. The source electrode 30e is electrically connected to the signal line 9. That is, each of the transistors 30 is electrically connected to the gate line 8 and the signal line 9.

The gate line 8 extends in the first direction X and is electrically connected to each of the transistors 30 in the plurality of detection areas R arrayed in the first direction X. The signal line 9 extends in the second direction Y, intersects the gate line 8, and is electrically connected to each of the transistors 30 in the plurality of detection areas R arrayed in the second direction Y. The detection electrode 50 is electrically connected to the drain electrode 30d.

Scanning the gate line 8 electrically connects the detection electrode 50 with the signal line 9. Thus, a value of a current flowing between the detection electrode 50 and the common electrode 60 can be obtained via the signal line 9. Pressure applied to the input surface 1a can be detected based on this obtained current value.

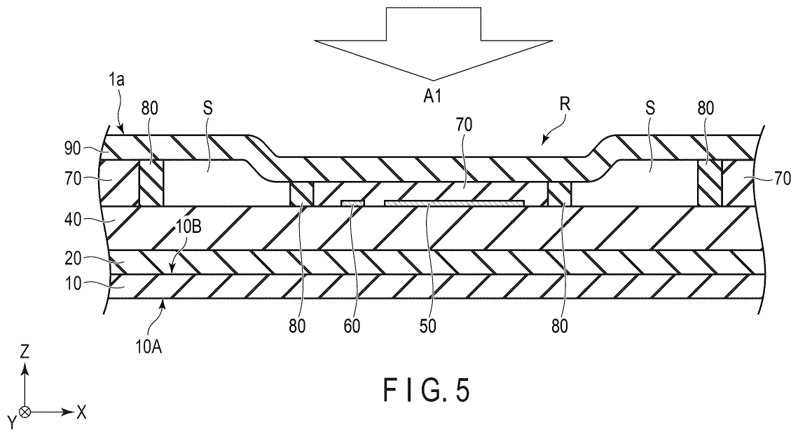

FIG. 5 is a cross-sectional view illustrating a state where the input surface 1a of the pressure sensor 1 is pressed. FIG. 5 omits the illustration of the transistors 30.

In the detection area R, the detection electrode 50 and the common electrode 60 are adjacent to each other via the pressure-sensitive layer 70. When the input surface 1a of the pressure sensor 1 is not pressed, the pressure-sensitive layer 70 has a greater resistance value. Thus, when the input surface 1a is not pressed, the detection electrode 50 and the common electrode 60 are electrically disconnected from each other.

As shown in FIG. 5, for example, when the input surface 1a is pressed by fingers and the like, pressure in a direction from the protective layer 90 to the substrate 10, in other words, in an A1 direction is applied to the input surface 1a. At this time, in the detection area R, the pressure-sensitive layer 70 is compressed in the A1 direction. Thus, the conductive materials contained in the pressure-sensitive layer 70 are brought into contact with one another or close proximity. This decreases the resistance value of the pressure-sensitive layer 70. Thus, a current flows between the detection electrode 50 and the common electrode 60 via the pressure-sensitive layer 70.

When pressure in the A1 direction applied to the input surface 1a increases, the pressure-sensitive layer 70 is further compressed in the A1 direction. This increases the amount of the conductive materials that are brought into contact with one another or close proximity. This reduces the resistance value of the pressure-sensitive layer 70 further and increases a current flowing between the detection electrode 50 and the common electrode 60 via the pressure-sensitive layer 70. That is, as pressure applied to the input surface 1a increases, a value of a current (current value) flowing between the detection electrode 50 and the common electrode 60 via the pressure-sensitive layer 70 increases. Variations in pressure applied to the input surface 1a can be detected by detecting such variations in the current value.

The present embodiment can provide a pressure sensor capable of suppressing reduction in reliability.

For example, when a pressure-sensitive layer is formed by applying a pressure-sensitive layer material to desired positions by ink-jet, printing, and the like in the manufacture of the pressure sensor, a pressure-sensitive layer material may be applied to undesired positions depending on the accuracy of application and the like. Further, depending on viscosity of the pressure-sensitive layer material, uncured pressure-sensitive layer material may spread and thus be applied to undesired positions. This may vary the thickness of the pressure-sensitive layer. This may decrease the reliability of the pressure sensor as well.

The pressure sensor 1 shown in FIG. 2 and FIG. 3 comprises the plurality of detection areas R. Each of the plurality of detection areas R comprises the pressure-sensitive layer 70. The partition 80 is provided between two pressure-sensitive layers 70 adjacent to each other. This suppress the pressure-sensitive layer material being applied to undesired positions in the manufacturing of the pressure sensor 1. Further, this suppresses spreading of the applied pressure-sensitive layer material.

Thus, the present embodiment can provide a pressure sensor capable of suppressing reduction in reliability.

### Second Embodiment

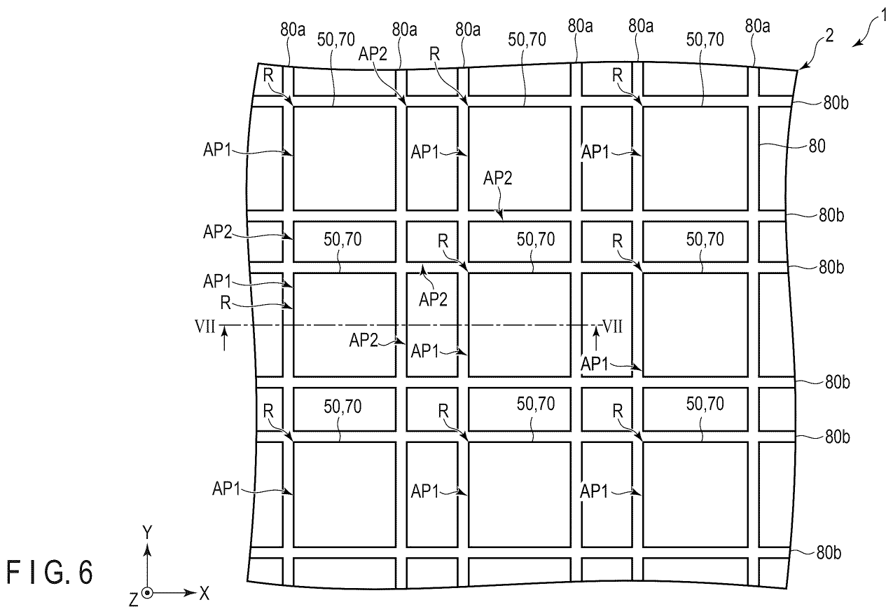

FIG. 6 is a plan view showing a configuration example of a pressure sensor 1 of the second embodiment. Configurations corresponding to those in the first embodiment adopt the above explanations and explanations of these corresponding configurations are omitted. The following describes a detection unit 2 of the pressure sensor 1. FIG. 6 omits the illustration of the protective layer 90.

The pressure sensor 1 comprises a plurality of detection areas R, a partition 80, and a common electrode 60 (not shown). In the example in FIG. 6, the plurality of detection areas R are arrayed in the first direction X and the second direction Y.

Each of the plurality of detection areas R comprises a detection electrode 50, a pressure-sensitive layer 70, and a transistor 30 (not shown). The pressure-sensitive layer 70 overlaps the detection electrode 50. In the example in FIG. 6, the pressure-sensitive layer 70 and the detection electrode 50 have a rectangular shape of the same size in plan view, although the pressure-sensitive layer 70 may have a size in plan view smaller than that of the detection electrode 50.

In the example in FIG. 6, the partition 80 includes a plurality of first partitions 80a arrayed in the first direction X and extending in the second direction Y and a plurality of second partitions 80b arrayed in the second direction Y and extending in the first direction X. Two of the first partitions 80a are provided between the pressure-sensitive layers 70 adjacent to each other in the first direction X. Two of the second partitions 80b are provided between the pressure-sensitive layers 70 adjacent to each other in the second direction Y. The first partition 80a and the second partition 80b intersecting each other are connected to each other. Thus, as a whole, the partition 80 is formed into a lattice shape surrounding each of the plurality of pressure-sensitive layers 70. The partition 80 includes a plurality of apertures AP1 overlapping the pressure-sensitive layer 70. The partition 80 further comprises a plurality of apertures AP2 not overlapping the pressure-sensitive layer 70. In the example in FIG. 6, the aperture AP1 has a rectangular shape of the same size as the pressure-sensitive layer 70 in plan view.

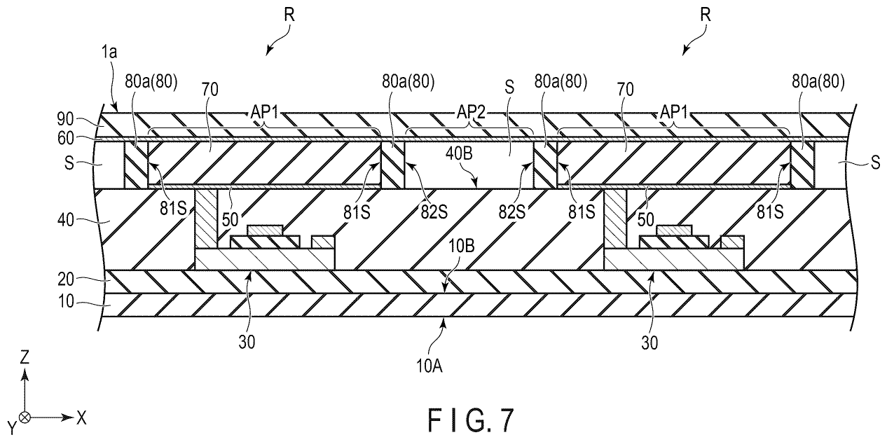

FIG. 7 is a schematic cross-sectional view of the pressure sensor 1 along VII-VII line in FIG. 6. Configurations corresponding to those in the first embodiment adopt the above explanations and explanations of these corresponding configurations are omitted.

The pressure sensor 1 comprises a substrate 10, an insulating layer 20, a plurality of transistors 30, an insulating layer 40, the plurality of detection electrodes 50, the common electrode 60, the plurality of pressure-sensitive layers 70, the partition 80, and the protective layer 90.

Each of the plurality of detection electrodes 50 is provided on the surface 40B per the detection area R. Each of the plurality of pressure-sensitive layers 70 is formed per the detection area R. The pressure-sensitive layer 70 is provided on the detection electrode 50 to cover it.

The partition 80 is provided on the surface 40B. In the example in FIG. 7, two of the first partitions 80a are provided on the surface 40B between the pressure-sensitive layers 70 adjacent to each other. Each of the first partitions 80a has a side surface 81S facing the pressure-sensitive layer 70 and a side surface 82S on the side opposite to the side surface 81S. The side surface of one first partition 80a 81S faces the side surface 81S of another first partition 80a via the pressure-sensitive layer 70. The aperture AP1 is formed between side surfaces 81S facing each other. The detection electrode 50 and the pressure-sensitive layer 70 are provided in the aperture AP1.

The common electrode 60 covers each of the plurality of pressure-sensitive layers 70. In the example in FIG. 7, the common electrode 60 covers each of the plurality of pressure-sensitive layers 70, the partition 80, and the entire area of the pressure sensor 1. The common electrode 60 faces each of the plurality of detection electrodes 50 via the pressure-sensitive layer 70 in the third direction Z.

The protective layer 90 covers the common electrode 60. The protective layer 90 has an input surface 1a on the surface opposite to the surface facing the substrate 10. For example, the common electrode 60 is a metal film formed on a surface of the protective layer 90 on the side opposite to the input surface 1a. The pressure sensor 1 may not comprise the protective layer 90. In that case, the surface of the common electrode 60 opposite to the surface facing the substrate 10 serves as the input surface 1a.

In this manner, in the pressure sensor 1 of the second embodiment, each of the plurality of detection electrodes 50 is provided to face the common electrode 60. That is, the pressure sensor 1 of the second embodiment comprises what is called a facing-type electrode.

The pressure sensor 1 of the second embodiment achieves the same effects of those of the first embodiment.

### Third Embodiment

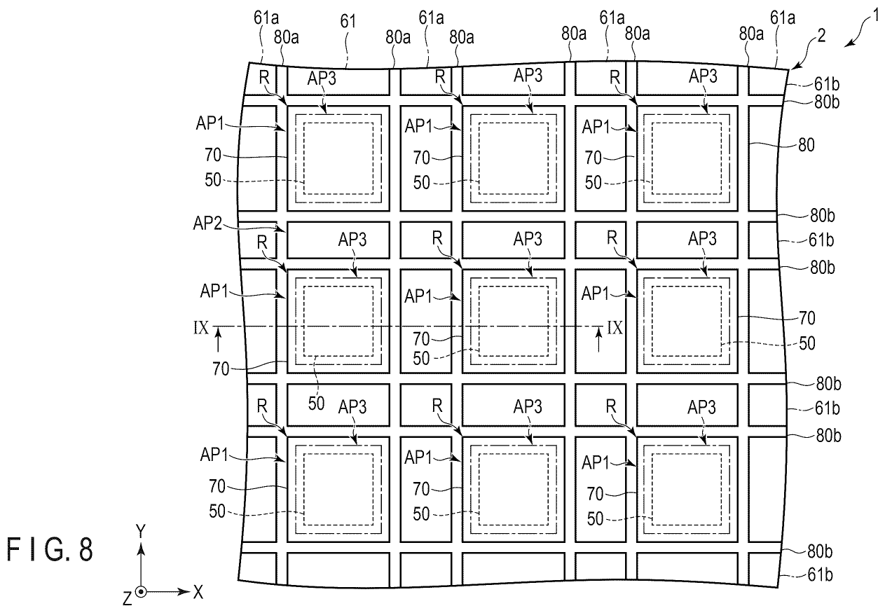

FIG. 8 is a plan view showing a configuration example of a pressure sensor 1 of the third embodiment. Configurations corresponding to those in the first embodiment adopt the above explanations and explanations of these corresponding configurations are omitted. The following describes a detection unit 2 of the pressure sensor 1. FIG. 8 omits the illustration of the protective layer 90.

The pressure sensor 1 comprises a plurality of detection areas R and a partition 80. The pressure sensor 1 further comprises a common electrode 61 and a common electrode 62 (not shown). In the example in FIG. 8, the plurality of detection areas R are arrayed in the first direction X and the second direction Y.

Each of the plurality of detection areas R comprises a detection electrode 50, a pressure-sensitive layer 70, and a transistor 30 (not shown). The pressure-sensitive layer 70 overlaps the detection electrode 50. In the example in FIG. 8, the pressure-sensitive layer 70 has a rectangular shape greater than the detection electrode 50 in plan view.

In the example in FIG. 8, the partition 80 includes a plurality of first partitions 80a arrayed in the first direction X and extending in the second direction Y and a plurality of second partitions 80b arrayed in the second direction Y and extending in the first direction X. Two of the first partitions 80a are provided between the pressure-sensitive layers 70 adjacent to each other in the first direction X. Two of the second partitions 80b are provided between the pressure-sensitive layers 70 adjacent to each other in the second direction Y. The first partition 80a and the second partition 80b intersecting each other are connected to each other. Thus, as a whole, the partition 80 is formed into a lattice shape surrounding each of the plurality of pressure-sensitive layers 70. The partition 80 includes a plurality of apertures AP1 overlapping the pressure-sensitive layer 70. The partition 80 further comprises a plurality of apertures AP2 not overlapping the pressure-sensitive layer 70. In the example in FIG. 8, the aperture AP1 has a rectangular shape of the same size as the pressure-sensitive layer 70 in plan view.

The common electrode 61 is provided between two pressure-sensitive layers 50 adjacent to each other in the first direction X or the second direction Y. In the example in FIG. 8, the common electrode 61 comprises a plurality of first common electrodes 61a arrayed in the first direction X and extending in the second direction Y and a plurality of second common electrodes 61b arrayed in the second direction Y and extending in the first direction X. One of the first common electrodes 61a is provided between the detection electrodes 50 adjacent to each other in the first direction X. One of the second common electrodes 61b is provided between the detection electrodes 50 adjacent to each other in the second direction Y. The first common electrode 61a and the second common electrode 61b intersecting one another are connected to each other. Thus, as a whole, the common electrode 61 is formed into a lattice shape surrounding each of the plurality of detection electrodes 50. The common electrode 61 overlaps the partition 80.

As shown in long and short dash line in FIG. 8, the common electrode 61 comprises a plurality of apertures AP3 overlapping the detection electrode 50 and the aperture AP1. In the example in FIG. 8, the aperture AP3 has a rectangular shape greater than the detection electrode 50 and smaller than the aperture AP1 in plan view. The common electrode 61 overlaps the pressure-sensitive layer 70 between the edge portion of the aperture AP3 and the edge portion of the aperture AP1. The detection electrode 50 is spaced apart from the edge portion of the aperture AP3 and provided in the aperture AP3.

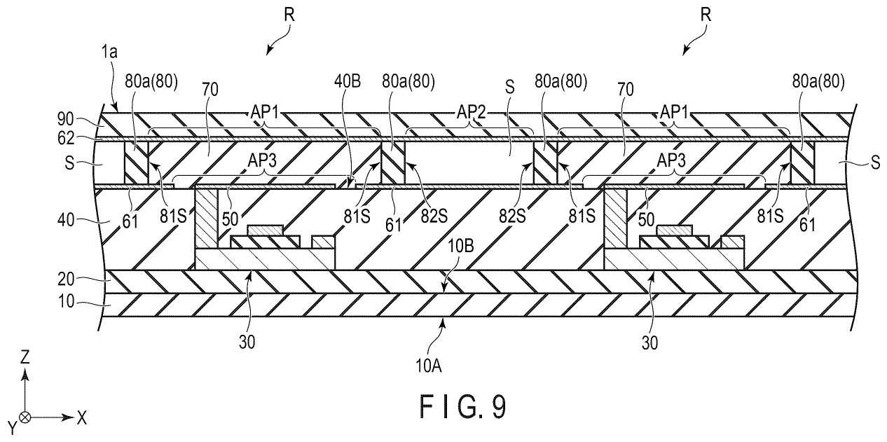

FIG. 9 is a schematic cross-sectional view of the pressure sensor 1 along IX-IX line in FIG. 8. Configurations corresponding to those in the first embodiment adopt the above explanations and explanations of these corresponding configurations are omitted.

The pressure sensor 1 comprises a substrate 10, an insulating layer 20, a plurality of transistors 30, an insulating layer 40, the plurality of detection electrodes 50, the common electrodes 61 and 62, the plurality of pressure-sensitive layers 70, the partition 80, and the protective layer 90.

Each of the plurality of detection electrodes 50 is provided on the surface 40B per the detection area R. Each of the plurality of detection electrodes 50 is provided in the aperture AP3 of the common electrode 61. The common electrode 61 is provided on the surface 40B between the detection electrodes 50 adjacent to each other. The detection electrode 50 and the common electrode 61 are adjacent to each other via the pressure-sensitive layer 70.

Each of the plurality of pressure-sensitive layers 70 is formed per the detection area R. The pressure-sensitive layer 70 covers the detection electrode 50. The pressure-sensitive layer 70 contacts the common electrode 61 between the edge portion of the aperture AP1 and the edge portion of the aperture AP3 in plan view. The pressure-sensitive layer 70 contacts the surface 40B between the detection electrode 50 and the common electrode 61.

In the example in FIG. 9, two of the first partitions 80a are provided on the common electrode 61 between the pressure-sensitive layers 70 adjacent to each other. Each of the first partitions 80a has a side surface 81S facing the pressure-sensitive layer 70 and a side surface 82S on the side opposite to the side surface 81S. The side surface 81S of one first partition 80a faces the side surface 81S of another first partition 80a via the pressure-sensitive layer 70. The aperture AP1 is formed between side surfaces 81S facing each other. Each of the detection electrode 50 and the pressure-sensitive layer 70 are provided in the aperture AP1.

The side surface 82S of one first partition 80a faces the side surface 82S of another first partition 80a through a gap S. The aperture AP2 is formed between side surfaces 82S facing each other. In the example in FIG. 9, the common electrode 61 is exposed in the aperture AP2.

The common electrode 62 covers each of the plurality of pressure-sensitive layers 70. In the example in FIG. 9, the common electrode 62 covers each of the plurality of pressure-sensitive layers 70, the partition 80, and the entire area of the pressure sensor 1. In the example in the figures, the common electrode 62 is formed into a sheet-like shape. The common electrode 62 faces the detection electrodes 50 via the pressure-sensitive layer 70 in the third direction Z. The common electrodes 61 and 62 have the same electric potential.

The protective layer 90 covers the common electrode 62. The protective layer 90 has an input surface 1a on the surface opposite to the surface facing the substrate 10. For example, the common electrode 62 is a metal film formed on a surface of the protective layer 90 on the side opposite to the input surface 1a.

In this manner, in the pressure sensor 1 of the third embodiment, each of the detection electrodes 50 is provided to be on the same plane as the common electrode 61 and to face the common electrode 62. That is, the pressure sensor 1 of the third embodiment comprises a hybrid-type electrode prepared by combining a facing-type electrode and a parallel-type electrode.

The pressure sensor 1 of the third embodiment achieves the same effects of those of the first embodiment.

### Configuration Example of Detection Unit 2

### Configuration Example 1

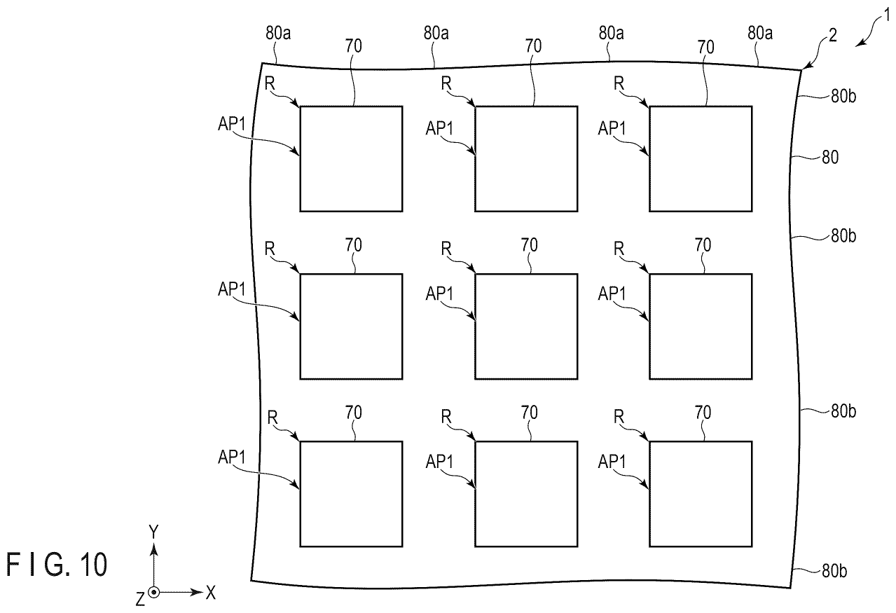

FIG. 10 is a plan view showing a configuration example of the detection unit 2. Configurations corresponding to those in the first embodiment adopt the above explanations and explanations of these corresponding configurations are omitted. FIG. 10 omits the illustration of the detection electrode 50, the common electrode 60, and the protective layer 90.

The pressure sensor 1 comprises a plurality of detection areas R and a partition 80. In the example in FIG. 10, the plurality of detection areas R are arrayed in the first direction X and the second direction Y. Each of the plurality of detection areas R comprises a pressure-sensitive layer 70, a transistor 30 (not shown), and a detection electrode 50 (not shown).

In the example in FIG. 10, the partition 80 includes the plurality of first partitions 80a arrayed in the first direction X and extending in the second direction Y and the plurality of second partitions 80b arrayed in the second direction Y and extending in the first direction X. One of the first partitions 80a is provided between the pressure-sensitive layers 70 adjacent to each other in the first direction X. One of the second partitions 80b is provided between the pressure-sensitive layers 70 adjacent to each other in the second direction Y. The first partition 80a and the second partition 80b intersecting each other are connected to each other. Thus, as a whole, the partition 80 is formed into a lattice shape surrounding each of the plurality of pressure-sensitive layers 70.

In the example in FIG. 10, the partition 80 includes a plurality of apertures AP1 overlapping the pressure-sensitive layer 70. In the partition 80, the plurality of apertures AP1 are arrayed in the first direction X and the second direction Y. The aperture AP1 has a rectangular shape of the same size as the pressure-sensitive layer 70 in plan view.

The pressure sensor 1 of the configuration example 1 achieves the same effects of those of the first embodiment.

### Configuration Example 2

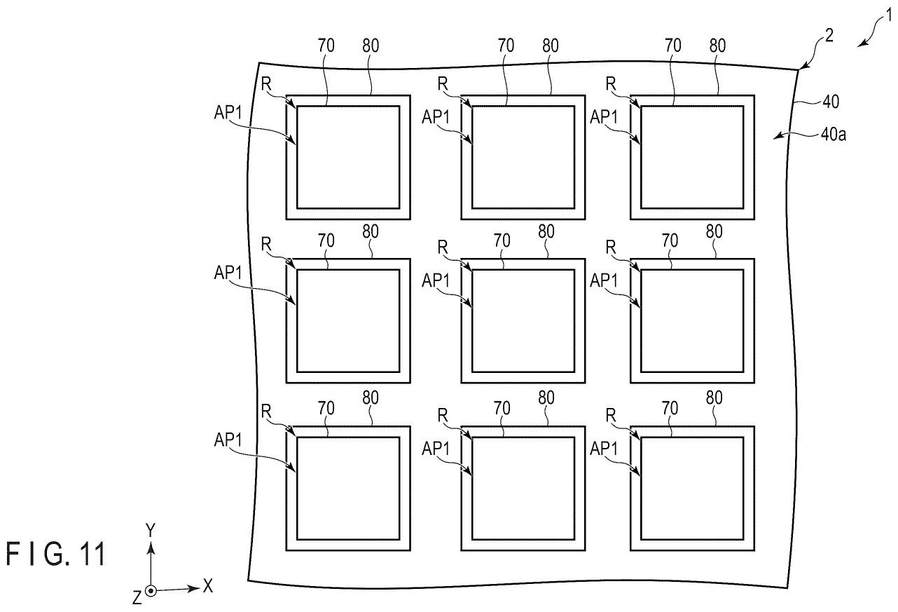

FIG. 11 is a plan view showing a configuration example of the detection unit 2. Configurations corresponding to those in the first embodiment adopt the above explanations and explanations of these corresponding configurations are omitted. FIG. 11 omits the illustration of the detection electrode 50, the common electrode 60, and the protective layer 90.

The pressure sensor 1 comprises a plurality of detection areas R and a plurality of partitions 80. In the example in FIG. 11, the plurality of detection areas R are arrayed in the first direction X and the second direction Y. Each of the plurality of detection areas R comprises the pressure-sensitive layer 70, a transistor 30 (not shown), and a detection electrode 50 (not shown).

Each of the plurality of partitions 80 has a frame shape surrounding the pressure-sensitive layer 70. Each of the plurality of partitions 80 comprises the aperture AP1 overlapping the pressure-sensitive layer 70. In the example in FIG. 11, the aperture AP1 has a rectangular shape of the same size as the pressure-sensitive layer 70 in plan view.

The pressure sensor 1 of the configuration example 2 achieves the same effects of those of the first embodiment.

### Configuration Example 3

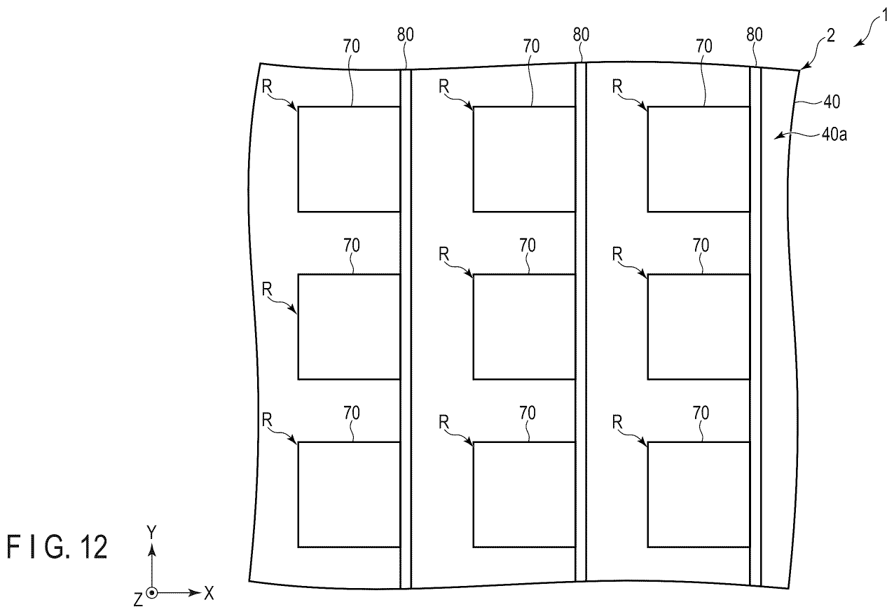

FIG. 12 is a plan view showing a configuration example of the detection unit 2. Configurations corresponding to those in the first embodiment adopt the above explanations and explanations of these corresponding configurations are omitted. FIG. 12 omits the illustration of the detection electrode 50, the common electrode 60, and the protective layer 90.

The pressure sensor 1 comprises a plurality of detection areas R and a plurality of partitions 80. In the example in FIG. 12, the plurality of detection areas R are arrayed in the first direction X and the second direction Y. Each of the plurality of detection areas R comprises the pressure-sensitive layer 70, a transistor 30 (not shown), and a detection electrode 50 (not shown).

In the example in FIG. 12, the plurality of partitions 80 are arrayed in the first direction X and extend in the second direction Y. One partition 80 is provided between the pressure-sensitive layers 70 adjacent to each other in the first direction X. Each of the plurality of partitions 80 contacts each of the plurality of pressure-sensitive layers 70 arrayed in the second direction Y.

The pressure sensor 1 of the configuration example 3 achieves the same effects of those of the first embodiment.

### Configuration Example 4

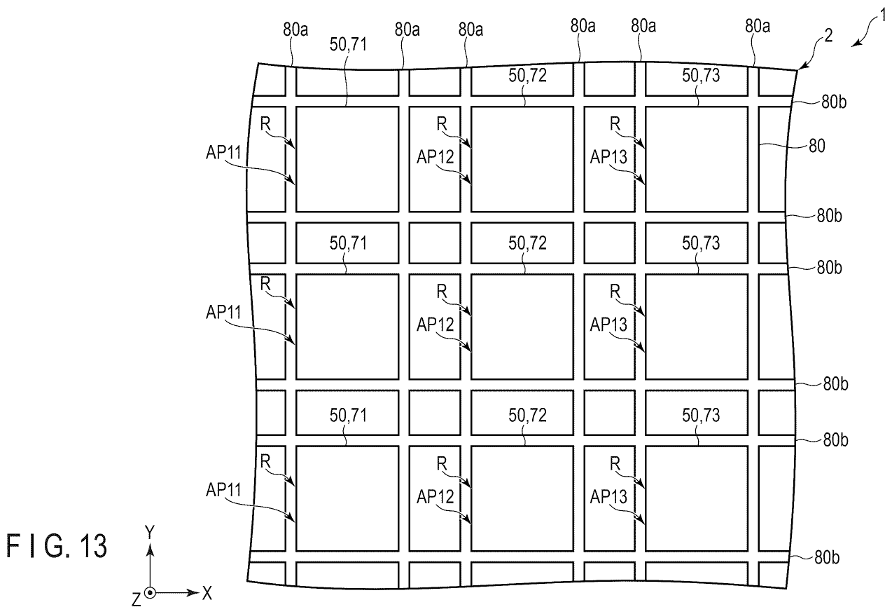

FIG. 13 is a plan view showing a configuration example of the detection unit 2. Configurations corresponding to those in the second embodiment adopt the above explanations and explanations of these corresponding configurations are omitted. FIG. 13 omits the illustration of the common electrode 60 and the protective layer 90.

The pressure sensor 1 comprises a plurality of detection areas R and a partition 80. In the example in FIG. 13, the plurality of detection areas R are arrayed in the first direction X and the second direction Y. The pressure sensor 1 comprises pressure-sensitive layers 71, 72, and 73 as pressure-sensitive layers. Each of the plurality of detection areas R comprises any one of the pressure-sensitive layers 71, 72, or 73. Each of the plurality of detection areas R further comprises a detection electrode 50 and a transistor 30 (not shown).

Each of the pressure-sensitive layers 71, 72, and 73 overlaps the detection electrode 50. For example, the pressure-sensitive layers 71, 72, and 73 have a rectangular shape of the same size in plan view. For example, the pressure-sensitive layers 71, 72, and 73 each have a rectangular shape of the same size as the detection electrode 50 in plan view. In the example in FIG. 13, the plurality of pressure-sensitive layers 71 are arrayed in the second direction Y, the plurality of pressure-sensitive layers 72 are arrayed in the second direction Y, and the plurality of pressure-sensitive layer 73 are arrayed in the second direction Y. The pressure-sensitive layers 71, 72, and 73 are arrayed in the first direction X in this order. Arrangements of the pressure-sensitive layers 71, 72, and 73 are not limited to this example.

In the example in FIG. 13, the pressure sensor 1 has the same number of the pressure-sensitive layers 71, 72, and 73. The numbers of these layers are not limited to this example and may be different from one another.

The pressure-sensitive layer 71, 72, and 73 have different variation ratios of resistance values in response to applied pressure. That is, degrees of variations in resistance values in response to variations in pressure differ between the pressure-sensitive layers 71, 72, and 73. Different types of the pressure-sensitive layers can be prepared by adjusting variation ratios of resistance values in response to applied pressure. For example, the variation ratios of resistance values in response to applied pressure may be adjusted by varying contents of the conductive materials in the insulating resins. Alternatively, the variation ratios of resistance values in response to applied pressure may be adjusted by varying conductivities of the conductive materials in the insulating resins. Alternatively, the variation ratios of resistance values in response to applied pressure may be adjusted by varying hardnesses of the insulating resins.

In the example in FIG. 13, the pressure sensor 1 comprises three types of pressure-sensitive layers. That is, the pressure sensor 1 comprises the pressure-sensitive layers 71, 72, and 73. The pressure-sensitive layer 71, 72, and 73 have different variation ratios of resistance values in response to applied pressure. The configuration of the pressure sensor 1 is not limited to this example. The pressure sensor 1 comprises at least two types of pressure-sensitive layers with different variation ratios of resistance values in response to pressure. The pressure sensor 1 may comprise four or more types of such pressure-sensitive layers.

In the example in FIG. 13, the partition 80 includes a plurality of first partitions 80a arrayed in the first direction X and extending in the second direction Y and a plurality of second partitions 80b arrayed in the second direction Y and extending in the first direction X. Two of the first partitions 80a are provided between the pressure-sensitive layers adjacent to each other in the first direction X. Two of the second partitions 80b are provided between the pressure-sensitive layers adjacent to each other in the second direction Y. The first partition 80a and the second partition 80b intersecting each other are connected to each other. Thus, as a whole, the partition 80 is formed into a lattice shape surrounding each of the plurality of pressure-sensitive layers 71, 72, and 73.

The partition 80 has a plurality of apertures AP11 overlapping the pressure-sensitive layer 71, a plurality of apertures AP12 overlapping the pressure-sensitive layer 72, and a plurality of apertures AP13 overlapping the pressure-sensitive layer 73. The aperture AP11 has a rectangular shape of the same size as the pressure-sensitive layer 71 in plan view. The aperture AP12 has a rectangular shape of the same size as the pressure-sensitive layer 72 in plan view. The aperture AP13 has a rectangular shape of the same size as the pressure-sensitive layer 73 in plan view. In the example in FIG. 13, the apertures AP11, 12, and 13 have a rectangular shape of the same size in plan view.

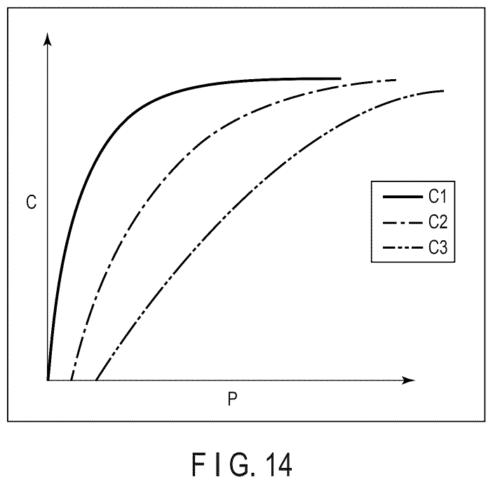

FIG. 14 is a view showing an example of relationships among pressures P applied to the input surface 1a and current values C. C1 refers to a value of a current flowing between the detection electrode 50 and the common electrode 60 via the pressure-sensitive layer 71. C2 refers to a value of a current flowing between the detection electrode 50 and the common electrode 60 via the pressure-sensitive layer 72. C3 refers to a value of a current flowing between the detection electrode 50 and the common electrode 60 via the pressure-sensitive layer 73.

The pressure-sensitive layer 71, 72, and 73 have different variation ratios of resistance values in response to pressures P. Thus, with respect to the relationships among the pressures P and the current values C, the current value C1, the current value C2, and the current value C3 in the pressure sensor 1 comprising the pressure-sensitive layers 71, 72, and 73 are shown by different lines, for example, as shown in FIG. 14. That is, how a current value C varies in response to a pressure P differs between the pressure-sensitive layers 71, 72, and 73. Thus, the pressure-sensitive layers 71, 72, and 73 have different ranges in which the variations in the pressure P can be detected with high accuracy.

In the example in FIG. 14, although the pressure-sensitive layer 71 can detect variations in the pressure P at low pressure with high sensitivity, it has a smaller range in which variations in the pressure P can be detected than that of the pressure-sensitive layer 72. Although the pressure-sensitive layer 72 has a lower sensitivity at low pressure than the pressure-sensitive layer 71, it has broader range in which variations in the pressure P can be detected than that of the pressure-sensitive layer 71. Thus, the pressure sensor 1 comprising both of the pressure-sensitive layers 71 and 72 can detect variations in the pressure P in the broader range of the pressures P than a pressure sensor that comprises the pressure-sensitive layer 71 alone. Further, the pressure sensor 1 can detect variations in the pressure P at low pressure with greater sensitivity than a pressure sensor that comprises the pressure-sensitive layer 72 alone.

This configuration allows the pressure sensor 1 to detect variations in pressure applied to the input surface 1a in a broader pressure range. Further, the pressure sensor can improve sensitivity of detection in a desired pressure range. The pressure sensor 1 of the configuration example 4 achieves the same effects of those of the first embodiment.

### Configuration Example 5

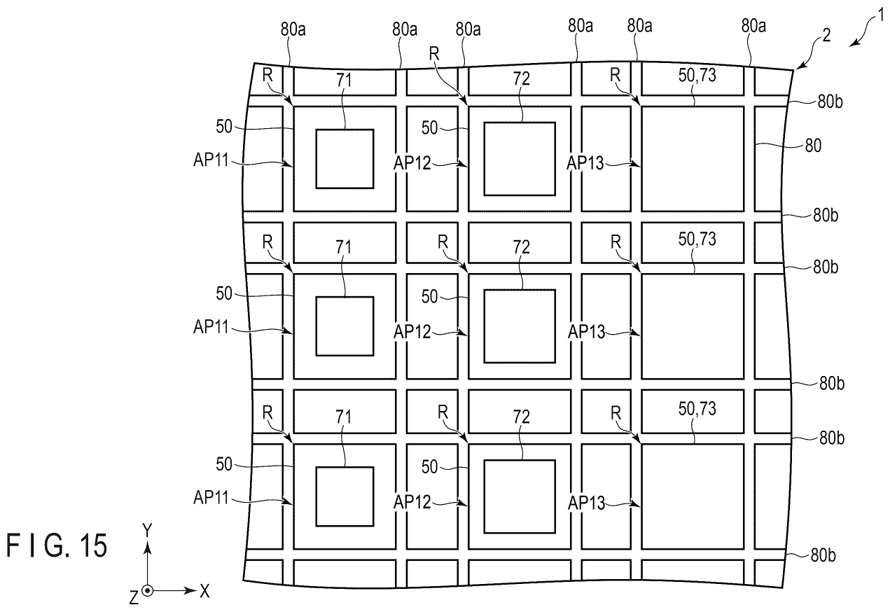

FIG. 15 is a plan view showing a configuration example of the detection unit 2. Configurations corresponding to those in the configuration example 4 adopt the above explanations and explanations of these corresponding configurations are omitted. FIG. 15 omits the illustration of the common electrode 60 and the protective layer 90. The pressure sensor 1 of the configuration example 5 is different from that of the configuration example 4 in the point that the pressure-sensitive layers 71, 72, and 73 have different sizes in plan view.

The pressure sensor 1 comprises the plurality of detection areas R and the partition 80. In the example in FIG. 15, the plurality of detection areas R are arrayed in the first direction X and the second direction Y. Each of the plurality of detection areas R comprises pressure-sensitive layers 71, 72, or 73. Each of the plurality of detection areas R further comprises the detection electrode 50 and the transistor 30 (not shown).

In the example in FIG. 15, the plurality of pressure-sensitive layers 71 are arrayed in the second direction Y, the plurality of pressure-sensitive layers 72 are arrayed in the second direction Y, and the plurality of pressure-sensitive layer 73 are arrayed in the second direction Y. The pressure-sensitive layers 71, 72, and 73 are arrayed in the first direction X in this order. Arrangements of the pressure-sensitive layers 71, 72, and 73 are not limited to this example.

The pressure-sensitive layers 71, 72, and 73 have different sizes in plan view. In the example in FIG. 15, the size of the pressure-sensitive layer 72 is greater than the pressure-sensitive layer 71, and the size of the pressure-sensitive layer 73 is greater than each of the pressure-sensitive layers 71 and 72. The magnitude relationships among these layers are not limited to this example. One of the pressure-sensitive layers 71, 72, and 73 may have the size in plan view different from those of the other two pressure-sensitive layers, and these other two pressure sensitive layers may have the same size in plan view.

Each of the pressure-sensitive layers 71, 72, and 73 overlaps the detection electrode 50. In the example in FIG. 15, the detection electrode 50 is greater than the pressure-sensitive layers 71 and 72 and has a rectangular shape of the same size as the pressure-sensitive layer 73 in plan view.

In the example in FIG. 15, the partition 80 includes the plurality of first partitions 80a arrayed in the first direction X and extending in the second direction Y and the plurality of second partitions 80b arrayed in the second direction Y and extending in the first direction X. Two of the first partitions 80a are provided between the pressure-sensitive layers adjacent to each other in the first direction X. Two of the second partitions 80b are provided between the pressure-sensitive layers adjacent to each other in the second direction Y. The first partition 80a and the second partition 80b intersecting each other are connected to each other. Thus, as a whole, the partition 80 is formed into a lattice shape surrounding each of the pressure-sensitive layers 71, 72, and 73.

The partition 80 has the plurality of apertures AP11 overlapping the pressure-sensitive layer 71, the plurality of apertures AP12 overlapping the pressure-sensitive layer 72, and the plurality of apertures AP13 overlapping the pressure-sensitive layer 73. The apertures AP11, AP12, and AP13 each have a rectangular shape of the same size as the pressure-sensitive layer 73 in plan view. The pressure-sensitive layers 71 and 72 each are spaced apart from the partition 80. The pressure-sensitive layer 73 contacts the partition 80.

The pressure sensor 1 of the configuration example 5 achieves the same effects of those of the configuration example 4.

### Configuration Example 6

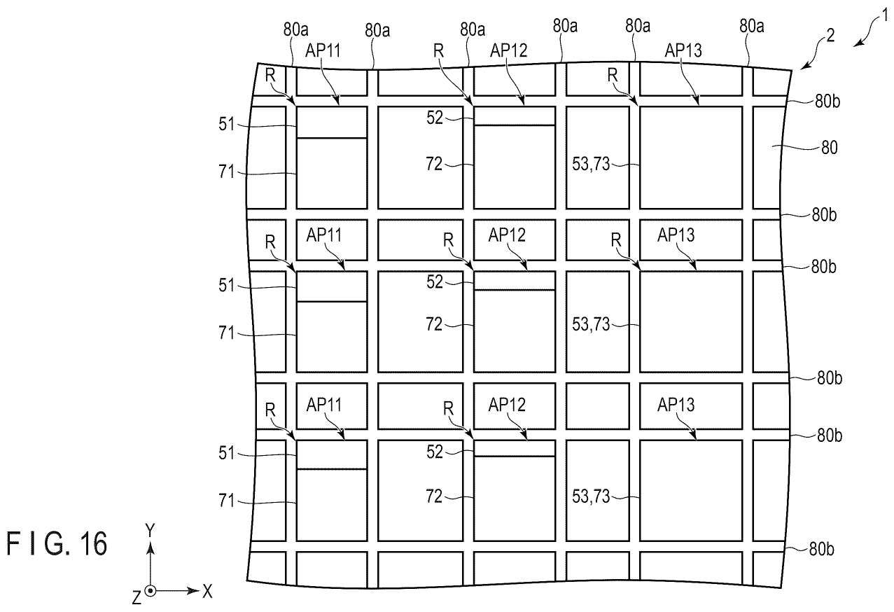

FIG. 16 is a plan view showing a configuration example of the detection unit 2. Configurations corresponding to those in the configuration example 5 adopt the above explanations and explanations of these corresponding configurations are omitted. FIG. 16 omits the illustration of the common electrode 60 and the protective layer 90. The pressure sensor 1 of the configuration example 6 is different from the configuration example 5 in the point that the aperture AP11 overlapping the pressure-sensitive layer 71, the aperture AP12 overlapping the pressure-sensitive layer 72, and the aperture AP13 overlapping the pressure-sensitive layer 73 have different sizes in plan view.

The pressure sensor 1 comprises the plurality of detection areas R and the partition 80. In the example in FIG. 16, the plurality of detection areas R are arrayed in the first direction X and the second direction Y. Each of the plurality of detection areas R comprises pressure-sensitive layers 71, 72, or 73. Each of the plurality of detection areas R further comprises detection electrodes 51, 52, or 53. Each of the plurality of detection areas R further comprises the transistor 30 (not shown).

The pressure-sensitive layer 71 overlaps the detection electrode 51. The pressure-sensitive layer 72 overlaps the detection electrode 52. The pressure-sensitive layer 73 overlaps the detection electrode 53.

In the example in FIG. 16, the plurality of pressure-sensitive layers 71 are arrayed in the second direction Y, the plurality of pressure-sensitive layers 72 are arrayed in the second direction Y, and the plurality of pressure-sensitive layer 73 are arrayed in the second direction Y. The pressure-sensitive layers 71, 72, and 73 are arrayed in the first direction X in this order. Arrangements of the pressure-sensitive layers 71, 72, and 73 are not limited to this example.

The pressure-sensitive layers 71, 72, and 73 have different sizes in plan view. In the example in FIG. 16, the pressure-sensitive layer 71 has a square shape. The pressure-sensitive layer 72 has a square shape greater than the pressure-sensitive layer 71. The pressure-sensitive layer 73 has a square shape greater than the pressure-sensitive layers 71 and 72. That is, the length of one side of the pressure-sensitive layer 72 is greater than the length of one side of the pressure-sensitive layer 71, and the length of one side of the pressure-sensitive layer 73 is greater than the length of one side of each of the pressure-sensitive layers 71 and 72.

In the example in FIG. 16, the partition 80 includes the plurality of first partitions 80a arrayed in the first direction X and extending in the second direction Y and the plurality of second partitions 80b arrayed in the second direction Y and extending in the first direction X. Two of the first partitions 80a are provided between the pressure-sensitive layers adjacent to each other in the first direction X. Two of the second partitions 80b are provided between the pressure-sensitive layers adjacent to each other in the second direction Y. The first partition 80a and the second partition 80b intersecting each other are connected to each other. Thus, as a whole, the partition 80 is formed into a lattice shape surrounding each of the plurality of pressure-sensitive layers 71, 72, and 73.

The partition 80 has a plurality of apertures AP11 overlapping the pressure-sensitive layer 71, a plurality of apertures AP12 overlapping the pressure-sensitive layer 72, and a plurality of apertures AP13 overlapping the pressure-sensitive layer 73. The apertures AP11, AP12, and AP13 have different sizes in plan view. In the example in FIG. 16, the apertures AP11, AP12, and AP13 each have a rectangular shape. The length of the aperture AP11 in the first direction X is the same as the length of one side of the pressure-sensitive layer 71. The length of the aperture AP12 in the first direction X is the same as the length of one side of the pressure-sensitive layer 72. The length of the aperture AP13 in the first direction X is the same as the length of one side of the pressure-sensitive layer 73. The length of each of the pressure-sensitive layers 71, 72, and 73 in the second direction Y is the same as the length of one side of the pressure-sensitive layer 73. That is, the aperture AP12 has the size in plan view greater than the aperture AP 11, and the aperture AP13 has the size in plan view greater than the apertures AP11 and AP12.

In the example in FIG. 16, three sides of each of the pressure-sensitive layers 71 and 72 contact the partition 80, and one side of each of these layers is apart from the partition 80. In contrast, four sides (all sides) of the pressure-sensitive layer 73 contact the partition 80. The detection electrode 51 has a rectangular shape of the same size as the aperture AP11 in plan view, the detection electrode 52 has a rectangular shape of the same size as the aperture AP12 in plan view, and the detection electrode 53 has a rectangular shape of the same size as the aperture AP13 in plan view.

The pressure sensor 1 of the configuration example 6 achieves the same effects of those of the configuration example 5.

The configuration examples in FIG. 10 to FIG. 13, FIG. 15, and FIG. 16 can be applied to any of pressure sensors comprising parallel-type electrodes, pressure sensors comprising facing-type electrodes, and pressure sensors comprising hybrid-type electrodes.

Thus, the present embodiment can provide a pressure sensor capable of suppressing reduction in reliability.

The present invention is not limited to the embodiments described above. At the stage of implementation, the present invention can be embodied with the constituent elements modified in various manners without departing from the spirit of the invention. Various aspects of the invention can also be extracted from any appropriate combination of a plurality of constituent elements disclosed in each of the embodiments. For example, some structural elements may be deleted from the entire structural elements in the embodiments. Furthermore, structural elements described in different embodiments may be combined suitably.

What is claimed is:

1. A pressure sensor, comprising:
a first detection area comprising:
a first transistor;
a first detection electrode electrically connected to the first transistor; and
a first pressure-sensitive layer provided on the first detection electrode,
a second detection area comprising:
a second transistor;
a second detection electrode electrically connected to the second transistor; and
a second pressure-sensitive layer provided on the second detection electrode; and
one or plurality of partitions provided between the first pressure-sensitive layer and the second pressure-sensitive layer.

2. The pressure sensor of claim 1, wherein
the partition is a lattice-shaped partition, and
the lattice-shaped partition has a first aperture overlapping the first pressure-sensitive layer and a second aperture overlapping the second pressure-sensitive layer in plan view.

3. The pressure sensor of claim 1, wherein
the partitions have a first frame-shaped partition and a second frame-shaped partition,
the first frame-shaped partition surrounds the first pressure-sensitive layer,
the second frame-shaped partition surrounds the second pressure-sensitive layer,
the first frame-shaped partition has a first aperture overlapping the first pressure-sensitive layer in plan view, and
the second frame-shaped partition has a second aperture overlapping the second pressure-sensitive layer in plan view.

4. The pressure sensor of claim 1, wherein
the partition is formed of an insulating material.

5. The pressure sensor of claim 1, wherein
the partition is formed of an acrylic resin or an epoxy resin.

6. The pressure sensor of claim 1, wherein
the first pressure-sensitive layer and the second pressure-sensitive layer each are formed of an insulating resin containing conductive materials.

7. The pressure sensor of claim 1, wherein
the first pressure-sensitive layer and the second pressure-sensitive layer have different variation ratios of resistance values in response to applied pressure.

8. The pressure sensor of claim 1, wherein
the first pressure-sensitive layer and the second pressure-sensitive layer have different sizes in plan view.

9. The pressure sensor of claim 2, wherein
the first aperture and the second aperture have different sizes in plan view.

10. The pressure sensor of claim 3, wherein
the first aperture and the second aperture have different sizes in plan view.

11. The pressure sensor of claim 1, further comprising:
an insulating layer covering the first transistor and the second transistor, wherein
the first detection electrode and the second detection electrode are provided on the insulating layer, and
the partition is provided on the insulating layer.

12. The pressure sensor of claim 11, further comprising:
one or plurality of common electrodes provided on the insulating layer.

13. The pressure sensor of claim 12, wherein
the common electrodes includes a first common electrode and a second electrode,
the first common electrode overlaps the first pressure-sensitive layer in plan view,
the second common electrode overlaps the second pressure-sensitive layer in plan view,
the first detection electrode and the first common electrode are provided on the same plane,
the second detection electrode and the second common electrode are provided on the same plane,
the first detection electrode and the first common electrode are adjacent to each other via the first pressure-sensitive layer, and
the second detection electrode and the second common electrode are adjacent to each other via the second pressure-sensitive layer.

14. The pressure sensor of claim 11, further comprising:
a common electrode provided on the first pressure-sensitive layer and the second pressure-sensitive layer.

15. The pressure sensor of claim 14, wherein
the common electrode covers each of the first pressure-sensitive layer, the second pressure-sensitive layer, and the partition,
the first detection electrode faces the common electrode via the first pressure-sensitive layer, and
the second detection electrode faces the common electrode via the second pressure-sensitive layer.

16. The pressure sensor of claim 11, wherein
the pressure sensor further comprises:
a lattice-shaped common electrode provided on the insulating layer; and
a sheet-like common electrode provided on the first pressure-sensitive layer and the second pressure-sensitive layer;
the lattice-shaped common electrode overlaps the partition in plan view,
the lattice-shaped common electrode has a plurality of apertures,
each of the first detection electrode and the second detection electrode is provided on any one of the plurality of apertures,
each of the first detection electrode and the second detection electrode is provided on the same plane as the lattice-shaped common electrode,
the first detection electrode and the lattice-shaped common electrode are adjacent to each other via the first pressure-sensitive layer,
the second detection electrode and the lattice-shaped common electrode are adjacent to each other via the second pressure-sensitive layer,
the sheet-like common electrode covers each of the first pressure-sensitive layer, the second pressure-sensitive layer, and the partition,
the first detection electrode faces the sheet-like common electrode via the first pressure-sensitive layer, and
the second detection electrode faces the sheet-like common electrode via the second pressure-sensitive layer.
